(19) United States
(12) Patent Application Publication
(10) Pub. No.: US 2021/0130658 A1
(43) Pub. Date: May 6, 2021

(54) ADHESIVE TAPE

(71) Applicant: TERAOKA SEISAKUSHO CO., LTD., Shinagawa-ku, Tokyo (JP)

(72) Inventor: Toshihiro YAMAGATA, Shinagawa-ku, Tokyo (JP)

(21) Appl. No.: 16/760,359

(22) PCT Filed: Oct. 31, 2017
(86) PCT No.: PCT/JP2017/039259

§ 371 Date: Jan. 12, 2021

(51) Int. Cl. C09J 9/02; C09J 11/04; C09J 7/28

(52) U.S. Cl. CPC C09J 9/02; C09J 11/04; C09J 7/28; C08K 3/08; C09J 2301/408; C09J 2301/314; C09J 2301/124; C09J 2301/312

(57) ABSTRACT

Disclosed in an adhesive tape having an adhesive layer containing a conductive filler on both sides of a conductive base, wherein the ratio (B/A) of the total thickness (B) of the adhesive layers to the thickness (A) of the conductive base is less than 2 and the content of the conductive filler is 45 parts by mass or more with respect to 100 parts by mass of the resin component of the adhesive layer. This adhesive tape has flame retardancy that passes UL94 HB (horizontal burning test) even if the adhesive layer does not contain a flame retardant, and further, is excellent also in thermal conductivity and adhesiveness.

### TECHNICAL FIELD

The present invention relates to an adhesive tape useful for fixing members in a power generation device such as, for example, a solar cell.

### BACKGROUND ART

In recent years, under the situation where countermeasures against greenhouse effect gases and environmental pollution are required, the development of energy alternatives to fossil energy such as crude oil, coal, and natural gas has been underway in order to realize a low-carbon society and a stable domestic supply of energy. Under these circumstances, solar power generation continues to spread as one of alternative energy. There are various solar power generation methods, but concentrated photovoltaic manifesting high power generation efficiency has been attracting attention for the sunbelt region where the amount of solar radiation is high.

Concentrated photovoltaic is a power generation method in which sunlight is collected in a power generation element through a condenser lens and converted into electric power, thus, high heat is applied to the power generation element. Most of the thermal energy generated at this time is converted into electric power, but the unconverted thermal energy may raise the temperature of the power generating element itself and reduce the conversion efficiency of the power generating element in some cases. Furthermore, since the solar power generation device is exposed to high temperature for a long period of time, ignition may occur due to partial insulation failure or spot heat generation. This risk becomes higher, especially in the case of the concentrated type which has high power generation efficiency.

When fixing the power generation part of the concentrated photovoltaic device to a housing, it is preferable to use an adhesive tape from the viewpoint of workability. Then, in order to suppress the temperature rise of the power generation element, it is necessary to impart thermal conductivity to the adhesive tape. As the thermally conductive adhesive tape, an adhesive tape in which an adhesive containing thermally conductive particles is formed on the surface of a metal base is typical. However, when the thermally conductive particles are blended with the adhesive, the adhesive property tends to deteriorate.

Further, in order to prevent the ignition described above, it is desirable to impart flame retardancy to the adhesive tape. For imparting flame retardancy, a method of blending, for example, a halogen-based, organic phosphorus-based, nitrogen-containing compound (melamine-based), metal hydroxide, antimony-based or red phosphorus-based flame retardant with the adhesive of the adhesive tape to impart flame retardancy to the adhesive tape is conceivable. However, the halogen-based flame retardant generates a toxic halogen-containing gas or corrodes metals when incinerated. Antimony oxide has been pointed out to possibly exert an adverse influence on the human body. The metal hydroxide or the nitrogen compound cannot obtain a flame retardant effect unless it is mixed in a large amount in the adhesive, and deteriorates the adhesive property. The red phosphorus-based flame retardant generates a harmful phosphine gas when incinerated. Ionic flame retardants such as ammonium polyphosphate and melamine polyphosphate cause reduction in electrolytic corrosion resistance. The liquid phosphate ester-based flame retardant plasticizes the adhesive layer to lower cohesive force. The phosphate ester-based flame retardant causes the flame retardant to deposit on the surface of the adhesive layer, lowers the adhesive property, and impairs the appearance. That is, any flame retardant has a problem. Hence, if there is a method capable of imparting flame retardancy to an adhesive tape without using a flame retardant, it is ideal.

Patent Document 1 discloses a conductive adhesive composition containing a conductive filler and a specific flame retardant such as red phosphorus, condensed phosphate ester, and melamine cyanurate. It is explained that this conductive adhesive composition has high flame retardancy and conductivity. However, the use of such flame retardants is undesirable for the reason described above. Furthermore, since both the flame retardant (inorganic material) and the conductive filler are added, the total addition amount of inorganic materials is increased, the adhesive property lowers, thus, it is considered that the composition cannot withstand long-term use.

Patent Document 2 discloses a flame-retardant adhesive sheet which contains no flame retardant and has a thin adhesive layer containing two specific types of resins. This flame-retardant adhesive sheet is described as having excellent flame retardancy and high adhesive force. However, since this flame-retardant adhesive sheet is provided with flame retardancy by thinning the adhesive layer, it may possibly not exhibit sufficient adhesiveness. For example, when using an adhesive tape for applications such as a solar power generation device, it is necessary to maintain a high adhesive force for a long period of time even when exposed to a high temperature. However, if the adhesive layer is thin like the adhesive sheet of Patent Document 2, adhesive force lowers only if the adhesive layer is slightly deteriorated, that is, the thin adhesive layer is not preferable. Further, Patent Document 2 does not consider thermal conductivity.

### RELATED ART DOCUMENTS

### Patent Documents

Patent Document 1: JP 2004-231792
Patent Document 2: WO2013/042560

### SUMMARY OF INVENTION

### Technical Problem

The present invention has been made in order to solve the problem of the conventional technique as described above. That is, the present invention has an object of providing an adhesive tape excellent in flame retardancy, thermal conductivity and adhesiveness.

### Solution to Problem

The present inventors have intensively studied to solve the above-described problem and resultantly found that it is very effective to adjust the balance between the thickness of the conductive base and the total thickness of the adhesive layers and to adjust the content of the conductive filler, leading to completion of the present invention.

That is, the present invention is an adhesive tape having an adhesive layer containing a conductive filler on both sides of a conductive base, wherein the ratio (B/A) of the total thickness (B) of the adhesive layers to the thickness (A) of the conductive base is less than 2 and the content of the conductive filler is 45 parts by mass or more with respect to 100 parts by mass of the resin component of the adhesive layer.

### Advantageous Effect of the Invention

The adhesive tape of the present invention is excellent in flame retardancy and thermal conductivity. Moreover, it has so high adhesiveness that it can maintain high adhesive force for a long time. Therefore, it is useful for various applications in fields requiring such characteristics, for example, for an application of fixing a power generation part to a housing in a power generation device, particularly in a concentrated photovoltaic device.

### MODES FOR CARRYING OUT THE INVENTION

### <Adhesive Layer>

The adhesive layer used in the present invention is provided on both sides of the conductive base. The adhesive used for the adhesive layer is not particularly limited. Specific examples thereof include acrylic adhesives, rubber-based adhesives, silicone-based adhesives and urethane-based adhesives. Among them, acrylic adhesives are preferable because they are inexpensive and have excellent heat resistance.

The type of the acrylic copolymer (Ac) constituting the acrylic adhesive is not particularly limited, but the acrylic copolymer containing a (meth)acrylic acid alkyl ester (Ac1) having an alkyl group having 1 to 3 carbon atoms, a (meth)acrylic acid alkyl ester (Ac2) having an alkyl group having 4 to 12 carbon atoms, a carboxyl group-containing monomer (Ac3), a hydroxyl group-containing monomer (Ac4) and vinyl acetate (Ac5) as constituent components of the polymer chain are preferred.

Specific examples of the (meth)acrylic acid alkyl ester (Ac1) include methyl (meth)acrylate, ethyl (meth)acrylate, and propyl (meth)acrylate. Of these, methyl (meth)acrylate is preferable. The content of the (meth)acrylic acid alkyl ester (Ac1) is preferably 20% by mass or less, more preferably 16% by mass or less, and particularly preferably 2 to 15% by mass in 100% by mass of the constituent components (monomer units) of the acrylic copolymer (Ac).

Specific examples of the (meth)acrylic acid alkyl ester (Ac2) include butyl (meth)acrylate, isobutyl (meth)acrylate, 2-ethylhexyl (meth)acrylate, octyl (meth)acrylate, isooctyl (meth)acrylate, isononyl (meth)acrylate and lauryl (meth)acrylate. Of these, butyl (meth)acrylate and 2-ethylhexyl (meth)acrylate are preferable. The content of the (meth)acrylic acid alkyl ester (Ac2) is preferably 50 to 97% by mass, and more preferably 65 to 90% by mass in 100% by mass of the constituent components (monomer units) of the acrylic copolymer (Ac).

Specific examples of the carboxyl group-containing monomer (Ac3) include acrylic acid, methacrylic acid, itaconic acid, crotonic acid, maleic acid, fumaric acid, 2-carboxy-1-butene, 2-carboxy-1-pentene, 2-carboxy-1-hexene and 2-carboxy-1-heptene. Among them, acrylic acid and methacrylic acid are preferable, and acrylic acid is more preferable. The content of the carboxyl group-containing monomer (Ac3) is preferably 3.5 to 15% by mass, and more preferably 7 to 12% by mass in 100% by mass of the constituent components (monomer units) of the acrylic copolymer (Ac).

Specific examples of the hydroxyl group-containing monomer (Ac4) include 2-hydroxyethyl (meth)acrylate, 3-hydroxypropyl (meth)acrylate and 4-hydroxybutyl (meth)acrylate. The content of the hydroxyl group-containing monomer (Ac4) is preferably 0.01 to 2% by mass, and more preferably 0.05 to 0.5% by mass in 100% by mass of the constituent components (monomer units) of the acrylic copolymer (Ac).

The content of vinyl acetate (Ac5) is preferably 5% by mass or less, and more preferably 1 to 4% by mass in 100% by mass of the constituent components (monomer units) of the acrylic copolymer (Ac).

The polymerization method for obtaining the acrylic copolymer (Ac) is not particularly limited, but radical solution polymerization is preferable from the viewpoint of easy polymer design. Alternatively, an acrylic syrup composed of the acrylic copolymer (Ac) and its monomer may be prepared first, and a crosslinking agent and an additional photopolymerization initiator may be added to the acrylic syrup for polymerization.

In the production of the acrylic copolymer (Ac), monomers other than the components (Ac1) to (Ac5) may be copolymerized as long as the effect of the present invention is not impaired.

The acrylic copolymer (Ac) preferably further contains a crosslinking agent. The crosslinking agent is a compound blended to react with the acrylic copolymer (Ac) to form a cross-linked structure. In particular, a compound capable of reacting with the carboxyl group and/or hydroxyl group of the acrylic copolymer (Ac) is preferable, and an isocyanate-based crosslinking agent is more preferable. Specific examples of the isocyanate-based crosslinking agent include tolylene diisocyanate, xylene diisocyanate, hexamethylene diisocyanate, isophorone diisocyanate, and modified prepolymers thereof. These may be used in combination of two or more.

The blending amount of the crosslinking agent is preferably 0.02 to 2 parts by mass or more, more preferably 0.03 to 1 part by mass, and particularly preferably 0.3 to 0.9 parts by mass with respect to 100 parts by mass of the acrylic copolymer (Ac).

A resin component other than the acrylic copolymer (Ac) can be used together within a range that does not impair the effect of the present invention. Specific examples thereof include tackifying resins such as rosin-based tackifiers, terpene resins, petroleum-based resins, terpene phenol-based resins and styrene-based resins.

The adhesive layer used in the present invention contains a conductive filler. The conductive filler is a component for imparting flame retardancy and thermal conductivity to the adhesive tape. The kind of the conductive filler is not particularly limited, and a known conductive filler known to be usable in the adhesive composition can be used. Specific examples of the material forming the conductive filler include metals such as nickel, copper, chromium, gold and silver or alloys or modified products thereof, carbon and graphite. A conductive resin filler having a resin surface coated with a metal can also be used. Two or more conductive fillers may be used in combination. Of these, metal fillers are preferable, nickel-based conductive particles and copper-based conductive particles are more preferable, and nickel-based conductive particles are most preferable.

The shape of the conductive filler is not particularly limited, and a conductive filler having a known shape such as a filament shape, a spike shape, a flake shape, or a spherical shape can be used. Among them, the filament shape, the spike shape, and the flake shape are preferable, and the filament shape and the spike shape are more preferable, because the number of contacts between the conductive fillers is likely to increase and the electric resistance value becomes stable. The size of the conductive filler is not particularly limited, and a known size may be used. In general, the average particle size of the conductive filler is preferably 0.01 to 100 μm, more preferably 1 to 50 μm, and particularly preferably 5 to 40 μm.

The content of the conductive filler is 45 parts by mass or more, preferably 45 parts by mass or more and 300 parts by mass or less, more preferably 80 parts by mass or more and 250 parts by mass or less with respect to 100 parts by mass of the resin component of the adhesive layer.

Further, the preferable content of the conductive filler varies depending also on the thickness (A) of the conductive base and the total thickness (B) of the adhesive layers. For example, when the conductive base is relatively thick, it is possible to impart sufficient flame retardancy and thermal conductivity to the adhesive tape even if the content of the conductive filler is relatively small, but when also the adhesive layer is relatively thick, it is preferable that the content of the conductive filler is relatively large. On the other hand, when the conductive base is relatively thin, it is preferable that the content of the conductive filler is relatively large, but when also the adhesive layer is relatively thin, it may be necessary to relatively reduce the content of the conductive filler. However, if it is possible to relatively increase the content of the conductive filler even if the adhesive layer is relatively thin, increasing the content is also preferable. Specifically, when the thickness (A) of the conductive base is 40 μm or more (for example, 40 μm or more and 500 μm or less) and the total thickness (B) of the adhesive layers is 10 μm or more and 200 μm or less, the content of the conductive filler is preferably 45 parts by mass or more and 300 parts by mass or less, more preferably 80 parts by mass or more and 250 parts by mass or less with respect to 100 parts by mass of the resin component of the adhesive layer. In contrast, when the thickness (A) of the conductive base is less than 40 μm (for example, 3 μm or more and less than 40 μm) and the total thickness (B) of the adhesive layers is 10 μm or more and less than 80 μm, the content of the conductive filler is preferably 45 parts by mass or more and 300 parts by mass or less, more preferably 50 parts by mass or more and 200 parts by mass or less, particularly preferably 90 parts by mass or more and 200 parts by mass or less with respect to 100 parts by mass of the resin component of the adhesive layer.

The adhesive layer may further contain additives such as a silane coupling agent, an antioxidant, a rust preventive, a tackifier, a plasticizer, a softening agent, a metal deactivator, and a pigment within a range that does not impair the object of the present invention.

The adhesive layer does not necessarily need to contain a flame retardant, and has excellent flame retardancy even when it does not contain a flame retardant. Therefore, in the present invention, it is preferable that the adhesive layer does not contain a flame retardant. However, if the problem due to the inclusion of the flame retardant does not occur, the flame retardant may be contained.

### <Conductive Base>

The type of the conductive base used in the present invention is not limited, but a metal base (particularly a metal foil) is preferable from the viewpoint of excellent flame retardancy and thermal conductivity. Specific examples of the metal constituting the base include aluminum, copper, nickel, stainless steel, iron, chromium and titanium. Of them, aluminum and copper are preferable.

<Adhesive tape>

The adhesive tape of the present invention has an adhesive layer containing a conductive filler on both sides of a conductive base. In the present invention, it is important to adjust the ratio (B/A) of the total thickness (B) of the adhesive layers to the thickness (A) of the conductive base, and to adjust the content of the conductive filler. The total thickness (B) of the adhesive layers means the total thickness of the two adhesive layers on both sides of the conductive base.

The ratio (B/A) of the total thickness (B) of the adhesive layers to the thickness (A) of the conductive base is less than 2, preferably 0.2 or more and 1.9 or less, and more preferably 0.4 or more and 1.8 or less. In the present invention, excellent flame retardancy and thermal conductivity are exhibited by appropriately lowering this ratio (B/A). Note that flame retardancy or thermal conductivity may be improved when the content of the conductive filler in the adhesive layer is increased even if the ratio (B/A) is too high. However, that case is not preferable, since adhesiveness decreases due to a large amount of the conductive filler.

The thickness (A) of the conductive base is not particularly limited as long as it satisfies the above ratio (B/A). Usually, the thickness (A) of the conductive base is preferably 3 μm or more and 500 μm or less, more preferably 5 μm or more and 300 μm or less.

Also the thickness (B) of the adhesive layer is not particularly limited as long as it is a thickness satisfying the above ratio (B/A). Usually, the thickness (B) of the adhesive layer is preferably 10 μm or more and 200 μm or less, more preferably 20 μm or more and 100 μm or less.

The adhesive tape of the present invention has excellent flame retardancy. Specifically, it is preferable to have flame retardancy that passes UL94 HB (horizontal burning test). The acceptance criterion of UL94 HB (horizontal burning test) is specifically that the burning rate is 75 mm/min or less or that it is self-extinguishing.

The adhesive layer can be formed, for example, by coating the adhesive composition on a conductive base and heating it to cause a crosslinking reaction. It is also possible to coat the adhesive composition on a release paper or other film, heat it to cause a cross-linking reaction to form an adhesive layer, and attach this adhesive layer to both sides of the conductive base. For coating the adhesive composition, for example, a coating device such as a roll coater, a die coater or a lip coater can be used. When heating after coating, the solvent in the adhesive composition can also be removed together with the crosslinking reaction by heating.

The adhesive tape of the present invention can be suitably used for various applications requiring flame retardancy and thermal conductivity. For example, it is very useful as an adhesive tape for a power generation device used in an application of fixing a power generation part to a housing in power generation devices such as a concentrated photovoltaic device.

### EXAMPLES

Hereinafter, the present invention will be described in more detail with reference to examples. However, the present invention is not limited to these examples. In the following descriptions, “part” means part by mass.

### Production Example 1 (Preparation of Acrylic Copolymer (Ac))

Into a reaction apparatus quipped with a stirrer, a thermometer, a reflux condenser and a nitrogen gas inlet tube were charged 10 parts of methyl acrylate, 73 parts of 2-ethylhexyl acrylate, 4.9 parts of n-butyl acrylate, 10 parts of acrylic acid, 0.1 parts of 4-hydroxybutyl acrylate, 2.0 parts of vinyl acetate, ethyl acetate, n-dodecanethiol as a chain transfer agent, and 0.1 parts of lauryl peroxide as a peroxide-based radical polymerization initiator. A nitrogen gas was enclosed in the reaction apparatus, and a polymerization reaction was carried out at 68° C. for 3 hours and then at 78° C. for 3 hours under a nitrogen gas stream while stirring. Thereafter, it was cooled to room temperature and ethyl acetate was added additionally. As a result, an acrylic copolymer (Ac) having a solid concentration of 30% was obtained.

### Example 1

A crosslinking agent, a silane coupling agent, an antioxidant, and 100 parts of nickel-based conductive particles (manufactured by Vale, trade name: Nickel Powder Type 123, average particle size 12.5 μm) were added with respect to 100 parts of the solid component of the acrylic copolymer (Ac) obtained in Production Example 1, and these were mixed to prepare an acrylic adhesive composition.

This adhesive composition was coated onto a silicone-treated release paper so that the thickness after drying would be 34 μm. Then, the solvent was removed and dried at 110° C. and a crosslinking reaction was performed to form an adhesive layer. This adhesive layer was attached to both sides of an aluminum foil having a thickness of 20 μm. Then, it was cured at 40° C. for 3 days to obtain a conductive double-sided adhesive tape.

### Examples 2 to 7, Comparative Examples 1 to 7

Conductive double-sided adhesive tapes were obtained in the same manner as in Example 1, except that the type and thickness of the base, the thickness of the adhesive layer, and the type and amount of the conductive filler were changed as shown in Tables 1 and 2.

### <Evaluation Method>

The adhesive tapes of the above Examples and Comparative Examples were evaluated according to the following methods. The results are shown in Tables 1 and 2.

### [Flame Retardancy]

In UL94 HB (horizontal burning test), a sample of 13 mm×125 mm size was used, the test was performed under the condition that a 20 mm flame was applied to the end portion of the sample held horizontally for 30 seconds, and the sample was evaluated according to the following criteria.

“A”: Burning rate was 75 mm/min or less or self-extinguishing property was showed

“B”: Burning rate exceeded 75 mm/min

[Thermal conductivity]

A sample of 25 mm×25 mm size was used and sandwiched between heat sinks and loaded with 1 kg, the temperature difference of the heat sinks when heated and the temperature became constant was measured, and the sample was evaluated according to the following criteria.

“A”: Temperature difference was less than 8° C.

“B”: Temperature difference was 8° C. or more

### [Adhesiveness]

A sample of 10 mm×125 mm size was used, measured for the adhesive force (N/10 mm) to an adherend made of SUS according to conditions and method of JIS Z 0237, and evaluated according to the following criteria.

“A”: Adhesive force was 2 N/10 mm or more “B”: Adhesive force was less than 2 N/10 mm

### [Long-Term Adhesiveness]

A sample of 10 mm×125 mm size was used, accelerated at 125° C. for 100 hours, measured for the adhesive force (N/10 mm) to an adherend made of SUS according to conditions and method of JIS Z 0237, and evaluated according to the following criteria.

“A”: Adhesive force was 2 N/10 mm or more

“B”: Adhesive force was less than 2 N/10 mm

TABLE 1

| | | Example | | | | | | |
|---|---|---|---|---|---|---|---|---|
| | | 1 | 2 | 3 | 4 | 5 | 6 | 7 |
| Conductive | type | AL | AL | AL | AL | Cu | Cu | Cu |
| base | (A) thickness (μm) | 20 | 50 | 50 | 50 | 35 | 35 | 35 |
| Adhesive | type | Ac | Ac | Ac | Ac | Ac | Ac | Ac |
| layer | (B) total thickness | 34 | 50 | 50 | 50 | 60 | 60 | 60 |
| | (μm) | | | | | | | |
| Conductive | type | Nickel | Nickel | Nickel | Nickel | Nickel | Copper | Nickel |
| filler | addition amount | 100 | 106 | 64 | 150 | 120 | 120 | 85 |
| | (parts by mass) | | | | | | | |

| | | | | | | | |
|---|---|---|---|---|---|---|---|
| B/A | 1.7 | 1 | 1 | 1 | 1.7 | 1.7 | 1.7 |
| Flame retardancy | A | A | A | A | A | A | A |
| Thermal conductivity | A | A | A | A | A | A | A |
| Adhesiveness | A | A | A | A | A | A | A |
| Long-term adhesiveness | A | A | A | A | A | A | A |

TABLE 2

| | | Comparative Example | | | | | | |
|---|---|---|---|---|---|---|---|---|
| | | 1 | 2 | 3 | 4 | 5 | 6 | 7 |
| Conductive | Type | AL | AL | AL | AL | Cu | Cu | Cu |
| base | (A) Thickness (μm) | 50 | 50 | 50 | 20 | 18 | 9 | 7 |
| Adhesive | Type | Ac | Ac | Ac | Ac | Ac | Ac | Ac |
| layer | (B) Total thickness | 100 | 70 | 100 | 100 | 42 | 41 | 16 |
| | (μm) | | | | | | | |
| Conductive | Type | Nickel | Nickel | Nickel | Nickel | Copper | Copper | Nickel |
| filler | Addition amount | 190 | 43 | 85 | 85 | 25 | 27 | 4.5 |
| | (parts by mass) | | | | | | | |

| | | | | | | | |
|---|---|---|---|---|---|---|---|
| B/A | 2 | 1.4 | 2 | 5 | 2.3 | 4.6 | 2.3 |
| Flame retardancy | A | B | B | B | B | B | B |
| Thermal conductivity | B | B | B | B | B | B | B |
| Adhesiveness | B | A | A | A | A | A | A |
| Long-term adhesiveness | B | A | A | A | A | A | A |

The abbreviations in Tables 1 and 2 are as follows.

“Al”: Aluminum foil

“Cu”: Copper foil

“Ac”: Acrylic adhesive composition obtained in Production Example 1

“Nickel”: Nickel-based conductive particles (manufactured by Vale, trade name: Nickel Powder Type 123, average particle size 12.5 μm)

“Copper”: Copper-based conductive particles (manufactured by Fukuda Metal Foil & Powder Co., Ltd., trade name: Electrolyte Powder FCC-115, average particle size 20.4 μm)

### <Evaluation Result>

As shown in Table 1, the adhesive tapes of Examples 1 to 7 were excellent in flame retardancy, thermal conductivity, adhesiveness and long-term adhesiveness.

In contrast, the adhesive tape of Comparative Example 1 was inferior in thermal conductivity though the content of the conductive filler was large because the ratio (B/A) of the total thickness (B) of the adhesive layers to the thickness (A) of the conductive base was high, as shown in Table 2. It is considered that the reason why the adhesiveness and the long-term adhesiveness were poor was that the content of the conductive filler was too large.

The adhesive tape of Comparative Example 2 was inferior in flame retardancy and thermal conductivity because the content of the conductive filler was too small. It is considered that the reason why the adhesiveness and the long-term adhesiveness were excellent was that the content of the conductive filler was smaller than that in Comparative Example 1.

The adhesive tapes of Comparative Examples 3 and 4 were inferior in flame retardancy and thermal conductivity because the ratio (B/A) of the total thickness (B) of the adhesive layers to the thickness (A) of the conductive base was too high. It is considered that the reason why the adhesiveness and the long-term adhesiveness were excellent was that the content of the conductive filler was smaller than that in Comparative Example 1.

The adhesive tapes of Comparative Examples 5 to 7 were inferior in flame retardancy and thermal conductivity because the ratio (B/A) of the total thickness (B) of the adhesive layers to the thickness (A) of the conductive base was too high and the content of the conductive filler was too small. It is considered that the reason why the adhesiveness and the long-term adhesiveness were excellent was that the content of the conductive filler was smaller than that in Comparative Example 1.

### INDUSTRIAL APPLICABILITY

The adhesive tape of the present invention is excellent in flame retardancy and thermal conductivity. Moreover, it has so high adhesiveness that it can maintain high adhesive force for a long time. Therefore, it is very useful in a field where these characteristics are required, for example, for fixing members of a power generation device.

1. An adhesive tape having an adhesive layer containing a conductive filler on both sides of a conductive base, wherein the ratio (B/A) of the total thickness (B) of the adhesive layers to the thickness (A) of the conductive base is less than 2 and the content of the conductive filler is 45 parts by mass or more with respect to 100 parts by mass of the resin component of the adhesive layer.

2. The adhesive tape according to claim 1, wherein the ratio (B/A) of the total thickness (B) of the adhesive layers to the thickness (A) of the conductive base is 0.2 or more and 1.9 or less.

3. The adhesive tape according to claim 1, wherein the thickness (A) of the conductive base is 40 μm or more, the total thickness (B) of the adhesive layers is 10 μm or more and 200 μm or less, and the content of the conductive filler is 45 parts by mass or more and 300 parts by mass or less with respect to 100 parts by mass of the resin component of the adhesive layer.

4. The adhesive tape according to claim 3, wherein the thickness (A) of the conductive base is 40 μm or more and 500 μm or less.

5. The adhesive tape according to claim 1, wherein the thickness (A) of the conductive base is less than 40 μm, the total thickness (B) of the adhesive layers is 10 μm or more and less than 80 μm, and the content of the conductive filler is 45 parts by mass or more and 300 parts by mass or less with respect to 100 mass of the resin component of the adhesive layer.

6. The adhesive tape according to claim 5, wherein the thickness (A) of the conductive base is 3 μm or more and less than 40 μm.

7. The adhesive tape according to claim 1, wherein the conductive base is a metal base.

8. The adhesive tape according to claim 1, wherein the conductive filler is a metal filler.

9. The adhesive tape according to claim 1, which has a burning rate of 75 mm/min or less or self-extinguishing property in UL94 HB (horizontal burning test).

10. The adhesive tape according to claim 1, which is an adhesive tape for a power generation device.
